(19) United States
(12) Patent Application Publication
(10) Pub. No.: US 2008/0301276 A1
(43) Pub. Date: Dec. 4, 2008

(54) System and method for controlling and managing electronic communications over a network

(75) Inventor: Charles D. Jenkins, Mill Valley, CA (US)

Correspondence Address: Florin Corie;Stattler Johansen & Adeli LLP, Suite 480, 60 South Market Street, San Jose, CA, 95113, US

(73) Assignee: EC Control Systems LLC

(21) Appl. No.: 11/801,454

(22) Filed: May 9, 2007

(51) Int. Cl. G06F 15/16

(52) U.S. Cl. 709/223

(57) ABSTRACT

A system and method to control and manage electronic communications transmitted over a network are described. An electronic communication is generated at a point of origin coupled to a sender user. Status of the electronic communication is further managed at the point of origin based on a predetermined number of selectable parameters associated with the electronic communication. Specifically, a set of communication parameters are retrieved from at least one field of an electronic communication generated by a sender user. Selection of at least one identification parameter related to the electronic communication is further facilitated. An identifier code associated with the electronic communication is further generated based on the one or more identification parameters and the set of communication parameters. A duplicate copy of the electronic communication is finally generated and the duplicate copy and the associated identifier code are further stored in a data storage device designed to facilitate ready production of the stored electronic communication through various search protocols.

### TECHNICAL FIELD

The present invention relates generally to computer applications and, more particularly, to a system and method to control and manage electronic communications transmitted over a network.

### BACKGROUND OF THE INVENTION

The explosive growth of the Internet as a publication and interactive communication platform has created an electronic environment that is changing the way business is transacted and the way communications are perceived. As the Internet becomes increasingly accessible around the world, communications among users increase exponentially.

Electronic communications, such as, for example, electronic mail (email) messages, have revolutionized interpersonal interactions. Over the past decade, electronic communications have become the dominant means of communication in the United States and all over the world.

The pervasive use of various forms of electronic communications, especially email messages, has not only altered business and personal communications, but has brought with it an overwhelming and insurmountable management problem to participants, senders, recipients and their respective employers. Presently, it is all too common for electronic communications to be disseminated to unintended recipients, to be unnecessarily deleted instead of being saved in a secure location, and/or to be saved when in fact they should have been deleted. In addition, companies and other network users are storing massive amounts of electronic communications data that grows every day. The growing body of data is typically incapable of being managed because the associated expense to review, duplicate, organize, and maintain previously generated electronic communications data is prohibitive.

Thus, what is needed is a system and method to identify, organize, store, and retrieve electronic communications, while, at the same time, preventing the accumulation of burdensome, unmanaged data.

### SUMMARY OF THE INVENTION

A system and method to control and manage electronic communications transmitted over a network are described. An electronic communication is generated at a point of origin coupled to a sender user. Status of the electronic communication is further managed at the point of origin based on a predetermined number of selectable parameters associated with the electronic communication.

Specifically, a set of communication parameters are retrieved from at least one field of an electronic communication generated by a sender user. Selection of at least one identification parameter related to the electronic communication is further facilitated. An identifier code associated with the electronic communication is further generated based on the set of communication parameters and the one or more identification parameters. A duplicate copy of the electronic communication is finally generated. The duplicate copy and the associated identifier code are further stored in a data storage device designed to facilitate ready production of the stored electronic communication through various search protocols.

Other features and advantages of the present invention will be apparent from the accompanying drawings and from the detailed description, which follow below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a processing sequence to control and manage electronic communications, according to one embodiment of the invention;

FIG. 2 is a block diagram illustrating an exemplary network environment containing a system to control and manage electronic communications, according to one embodiment of the invention;

FIG. 3 is a block diagram illustrating an exemplary data storage module, which at least partially implements and supports the system to control and manage electronic communications, according to one embodiment of the invention;

FIG. 4 is a diagram illustrating a representation of an identifier code associated with each electronic communication, according to one embodiment of the invention;

FIG. 5 is a flow diagram illustrating a method to retrieve a set of communication parameters from one or more fields of the electronic communication, according to one embodiment of the invention;

FIG. 6 is a flow diagram illustrating a method to facilitate selection of one or more identification parameters associated with the electronic communication, according to one embodiment of the invention;

FIG. 7 is a flow diagram illustrating a method to control and manage electronic communications, according to an alternate embodiment of the invention;

FIG. 8 is a diagrammatic representation of a machine in the exemplary form of a computer system within which a set of instructions may be executed.

### DETAILED DESCRIPTION

A system and method to control and manage electronic communications transmitted over a network are described. In embodiments described in detail below, electronic communications, such as, for example, electronic mail messages, are systematically identified, organized, and stored at the point of origin to enable users to access and produce the stored data when necessary. For every controlled electronic communication generated by a network user, a duplicate communication is generated and stored within the system. An identifier code is generated for each electronic communication, each code element reflecting particular attributes of the corresponding communication. The attributes include information that enables the system to store and maintain the communication, such as, for example, substantive content, risk sensitivity, and/or temporal characteristics, as described in further detail below.

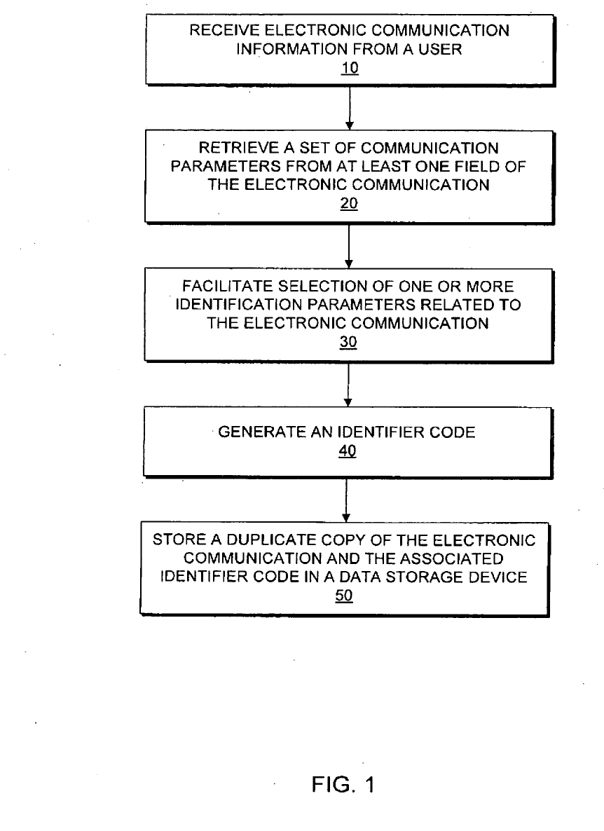

FIG. 1 is a flow diagram illustrating a processing sequence to control and manage electronic communications. As shown in FIG. 1, at processing block 10, the sequence starts with receipt of electronic communication information from a sender user. In one embodiment, the sender user performs an electronic communication set-up routine, such as, for example, creates an electronic mail message and inputs communication information within respective fields of the message, as described in further detail below. The system receives the communication information directly from the user, or, alternatively, from a network coupled to the user.

Next, at processing block 20, a set of communication parameters are retrieved from one or more fields of the electronic communication. In one embodiment, the system analyzes the communication information and retrieves one or more communication parameters from respective fields of the electronic communication, such as, for example, sender and recipient identification information, including electronic address, any employee code and/or position within an organization, if available, any attachment information, content information, whether the communication is transmitted intra-network or through an external network, and the date and time of the transmission, as described in further detail below.

At processing block 30, a selection of one or more identification parameters related to the electronic communication is facilitated through direct interface with the sender user. In one embodiment, the system facilitates selection by the sender user of one or more identification parameters, such as, for example, a category parameter associated with the electronic communication, a user-assessed risk level parameter for the transmission of the communication, a classification category parameter based on the substantive content of the communication, and a communication type parameter as described in further detail below. Subsequently, in one embodiment, the system stores the identification parameters into a data storage device, such as, for example, a storage database.

At processing block 40, an identifier code associated with the electronic communication is generated from the communication parameters and the selected identification parameters. In one embodiment, the system automatically assembles the identifier code elements to generate the identifier code sequence based on the communication parameters and the selected identification parameters, as described in further detail below.

Finally, at processing block 50, a duplicate copy of the electronic communication is generated and stored within the data storage device together with the corresponding identifier code, such that subsequent production of the electronic communication may be facilitated through various search protocols. In one embodiment, the system generates a duplicate copy of the communication and stores the copy and the associated identifier code within the data storage device, as described in further detail below.

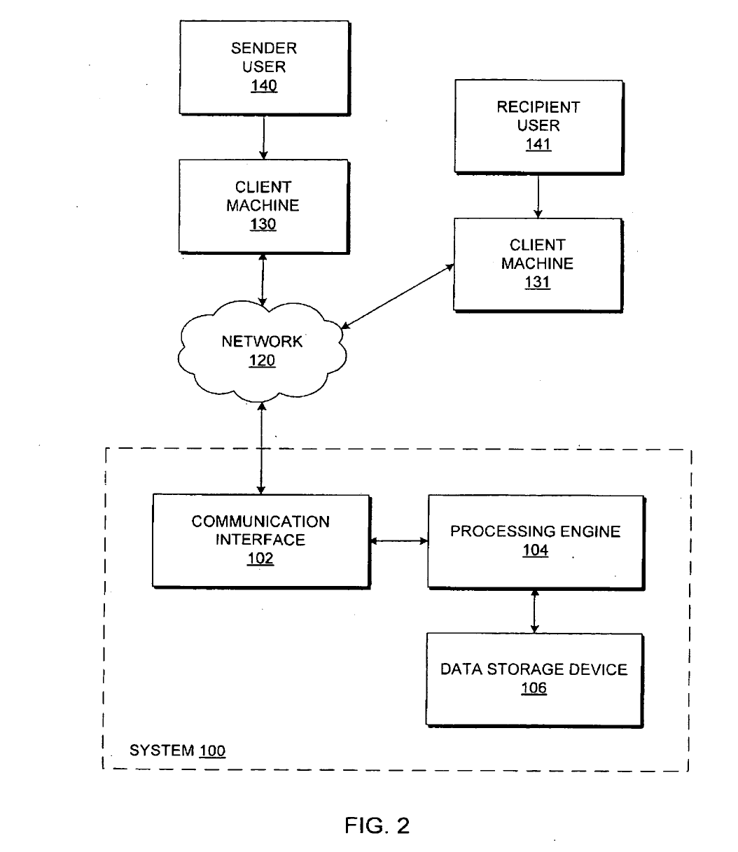

FIG. 2 is a block diagram illustrating an exemplary network environment containing a system to control and manage electronic communications. While an exemplary embodiment of the present invention is described within the context of a system 100 enabling such control and management operations, it will be appreciated by those skilled in the art that the invention will find application in many different embodiments of such system, such as, for example, a system 100 stored within a client machine 130 coupled to the sender user 140, a system administrator coupled to the sender user 140 via a network 120, and any other known types of computer-based, and network-based, entities, communicating directly with users or having a presence on the network.

In one embodiment, the system 100 includes a communication interface module 102, which may, for example, provide automated communications from/to the sender user 140 and a recipient user 141, respectively.

In one embodiment, the system 100 further includes a processing engine 104 coupled to a data storage device 106. The processing engine 104 may include software and/or hardware modules configured to perform control and management operations, as described in further detail below. The data storage device 106, which at least partially implements and supports the system 100, may include one or more storage facilities, such as a database or collection of databases, which may be implemented as relational databases, as described in further detail below. Alternatively, the data storage device 106 may be implemented as a collection of objects in an object-oriented database, as a distributed database, or any other such databases.

In one embodiment, the sender user 140 may access the system 100 through a client machine 130 coupled to the sender user 140 and the users 140 or, in the alternative, through a client program, such as a browser (e.g., the Internet Explorer browser distributed by Microsoft Corporation of Redmond, Wash.), that executes on the client machine 130 and accesses the system 100 via the network 120, such as, for example, the Internet. Other examples of networks that a client may utilize to access the entity 100 includes a wide area network (WAN), a local area network (LAN), a wireless network (e.g., a cellular network), or other known networks.

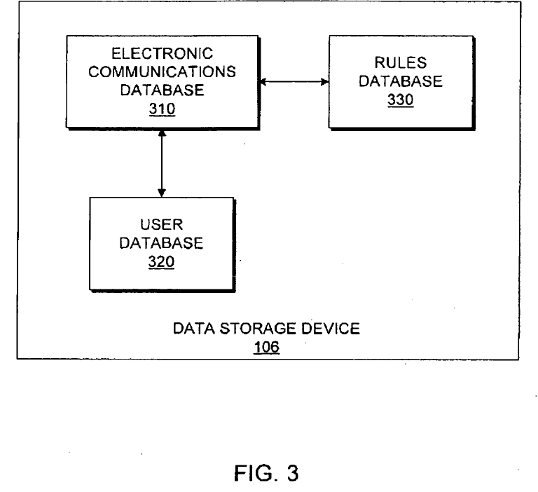

FIG. 3 is a block diagram illustrating an exemplary data storage device, which at least partially implements and supports the system to control and manage electronic communications. As shown in FIG. 3, in one embodiment, the data storage device 106, such as, for example, a database or collection of databases, further includes an electronic communications database 310 coupled to a user database 320 and further coupled to a rules database 330.

In one embodiment, the electronic communications database 310 is configured to store a duplicate copy of each electronic communication transmitted by the sender user 140, the identification parameters corresponding to the electronic communication, and the associated identifier code, as described in further detail below. The user database 320 is configured to store user identification information related to the sender user 140. The rules database 330 is configured to store multiple rule sets to be invoked and applied by the processing engine 104 within the system 100 to control how the electronic communication will behave after transmission to the system 100, such as, for example, rule sets to delete, discard, or destroy electronic communications that need not be maintained within the system 100.

In one embodiment, the sender user 140 connects to the client program running on the client machine 130 and performs an electronic communication set-up routine, such as, for example, creates an electronic mail message and inputs communication information within respective fields of the message. The communication information may include, for example, identification of the sender user 140 via a sender electronic mail address and other known information, identification of the recipient user 141 via a recipient electronic mail address and other known information, any attachment to be delivered to the recipient user 141, as well as a short description of the content.

In one embodiment, the processing engine 104 within the system 100 receives the communication information directly through the communication interface module 102 or, alternatively, via the network 120. Upon receipt of the communication information, the processing engine 104 retrieves the sender identification information, such as, for example, the electronic mail address of the sender user 140, an employee code and/or position within an organization, if available, and further retrieves the recipient identification information, such as, for example, the electronic mail address of the recipient user 141, an employee code and/or position within an organization, if available, from respective fields of the communication.

In one embodiment, the processing engine 104 may also extract additional data from corresponding fields within the electronic communication, such as whether the transmission of the electronic communication is completed through an intra-network, or, alternatively, via an external network, whether the communication includes an electronic attachment to be delivered to the recipient user 141, and some temporal information related to the communication, such as the date and time of the transmission.

Subsequently, in one embodiment, the processing engine 104 within the system 100 facilitates presentation and selection by the sender user 140 of one or more identification parameters related to the electronic communication via a succession of voice recognition prompts or, in the alternative, drop-down menus displayed in an interactive user interface within the client program running on the client machine 130. The sender user 140 selects the presented identification parameters with audible responses or, in the alternative, conventional mouse click commands and communicates the selections to the system 100 directly through the communication interface module 102 or, in the alternative, via the network 120.

In one embodiment, the processing engine 104 presents a voice recognition prompt or, in the alternative, a drop-down menu directing the sender user 140 to select a category associated with the electronic communication, such as, for example, a Business or Personal category. The sender user 140 selects the category and communicates the selected category to the processing engine 104.

Next, the processing engine 104 presents a voice recognition prompt or, in the alternative, a drop-down menu directing the sender user 140 to select a user-assessed risk level associated with the electronic communication. In one example, for a business-related communication, the voice recognition prompt or drop-down menu may include five risk levels, such as High Risk, Sensitive, Normal Risk, Not Sensitive, and Low Risk. Alternatively, for a personal communication, the voice recognition prompt or drop-down menu may include three risk levels, such as High Risk, Normal Risk, and Low Risk. The sender user 140 selects the appropriate risk level and communicates the selected risk level to the processing engine 104.

Next, the processing engine 104 presents a voice recognition prompt or, in the alternative, a drop-down menu directing the sender user 140 to select a classification category based on the substantive content of the electronic communication. These classification categories can be tailored to compartmentalize meaningfully the activities of an organization using a computer network. In one example, for a business-related communication, the voice recognition prompt or drop-down menu may include six classification categories, such as Technology, Marketing, Finance, Accounting, Human Resources, and Other Category. Alternatively, for a personal communication, the voice recognition prompt or drop-down menu may include five classification categories, such as Friends, Family, Commerce, Avocation, and Other Category. The sender user 140 selects the appropriate classification category and communicates the selected category to the processing engine 104.

In an alternate embodiment, the sender user 140 of a personal electronic communication may be allowed to tailor the control features on a transmission by transmission basis, such as, for example, No Print, No Forward, No Copy, and other such control features.

Next, the processing engine 104 presents a voice recognition prompt or, in the alternative, a drop-down menu directing the sender user 140 to indicate the type of electronic communication in question. In one example, for a business-related communication, the voice recognition prompt or drop-down menu may reference Legal Matter or Financial Data. Alternatively, for a personal electronic communication, the voice recognition prompt or drop-down menu may include a selection to indicate whether the content of the communication is in any way related to the network operator's interests. The sender user 140 selects the appropriate electronic communication type from the voice recognition prompt or drop-down menu and communicates the selected type to the processing engine 104.

It is to be understood by persons skilled in the art that various other identification parameters may be presented to the sender user 140 via voice recognition prompts or drop-down menus, or, in the alternative, via other known means of interactive communication without departing from the scope of the present invention. It is also to be understood that various other selection alternatives may be presented to the sender user 140 for each identification parameter and such selection may be further facilitated without departing from the scope of the present invention.

In one embodiment, the processing engine 104 stores the communication parameters and the selected identification parameters within respective tables of the electronic communications database 310. Alternatively, the processing engine 104 does not store the communication parameters and the identification parameters, but instead uses them directly to generate a unique identifier code associated with the electronic communication.

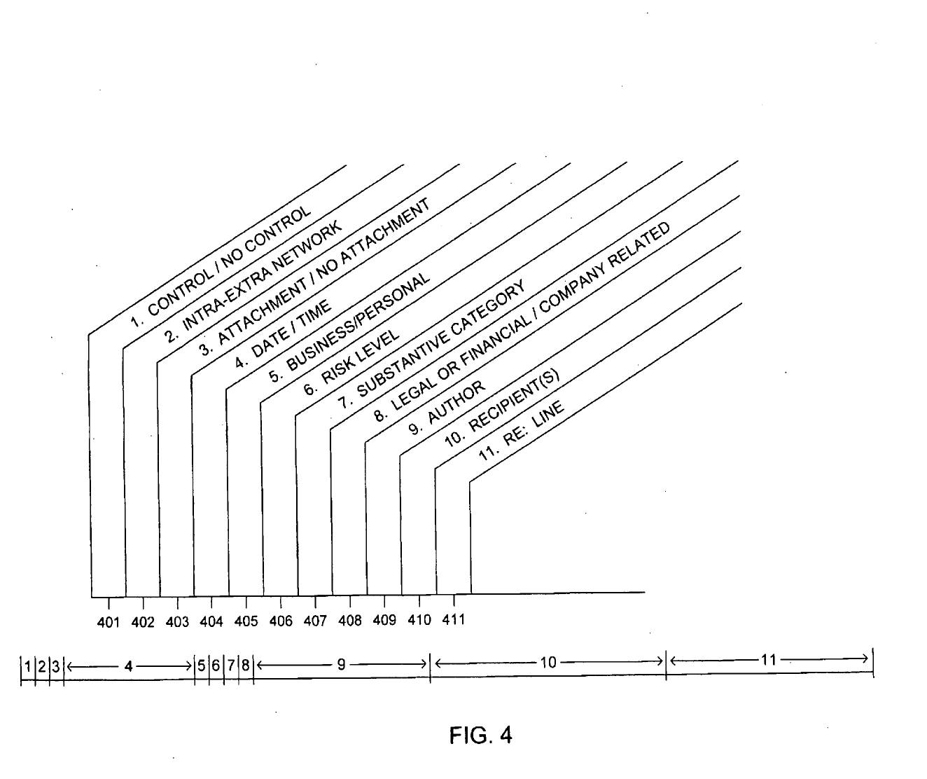

In one embodiment, the identifier code is systematically assembled code element by code element in a sequence that correlates with the information derived from the electronic communication. FIG. 4 is a diagram illustrating a representation of an identifier code associated with each electronic communication. As shown in FIG. 4, the identifier code 400 includes multiple fields, each field being respectively populated with the communication parameters retrieved from the communication information and the identification parameters selected by the sender user 140.

In one embodiment, a control field 401 includes a tag which indicates the level of control related to the electronic communication. A network field 402 includes data related to the type of transmission, i.e. whether the transmission of the electronic communication is completed intra-network, or, alternatively, via an external network.

Furthermore, an attachment field 403 includes a tag which indicates whether the communication has an attachment to be delivered to the recipient user 141. A temporal field 404 includes the temporal information related to the transmission, such as the date and time of the transmission.

In one embodiment, referring to the identification parameters, a category field 405 contains the category selection, a risk field 406 includes the risk level selection, a classification category field 407 includes the classification category selection, and a communication type field 408 includes the communication type selection.

Finally, in one embodiment, a sender field 409 contains the sender identification information, a recipient field 410 includes the recipient identification information, and a description field 411 includes the short description associated with each electronic communication.

Once generated, the identifier code 400 is further stored within the electronic communications database 310 together with a duplicate copy of the electronic communication. In one embodiment, the processing engine 104 generates a duplicate copy of the electronic communication and stores the electronic copy and the associated identifier code within the electronic communications database 310 of the data storage device 106.

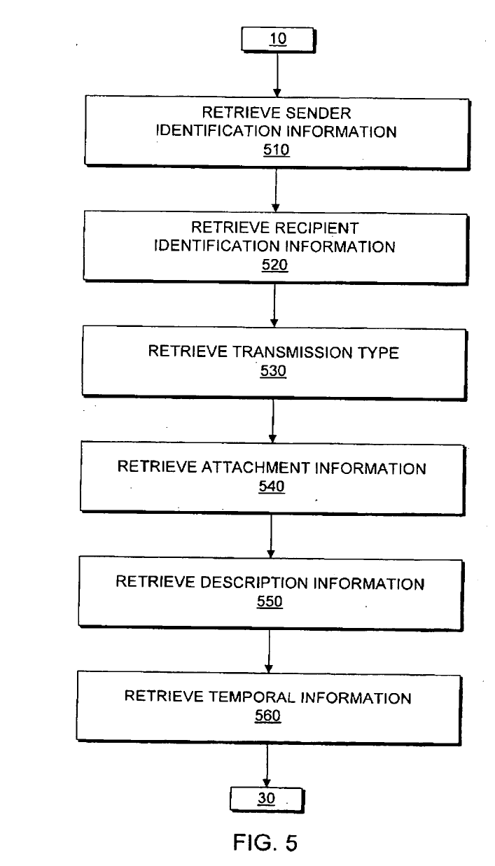

FIG. 5 is a flow diagram illustrating a method to retrieve a set of communication parameters from one or more fields of the electronic communication. As illustrated in FIG. 5, subsequent to receipt from a sender user 140 of electronic communication information, at processing block 510, sender identification information related to the electronic communication is retrieved from the communication information.

At processing block 520, recipient identification information related to the electronic communication is retrieved from the communication information. At processing block 530, a transmission type related to the electronic communication is retrieved from the communication information.

At processing block 540, attachment information related to the electronic communication is retrieved from the communication information. At processing block 550, description information related to the electronic communication is retrieved from the communication information. Finally, at processing block 560, temporal information related to the electronic communication is retrieved from the communication information. The procedure then jumps to processing block 30 detailed above in connection with FIG. 1.

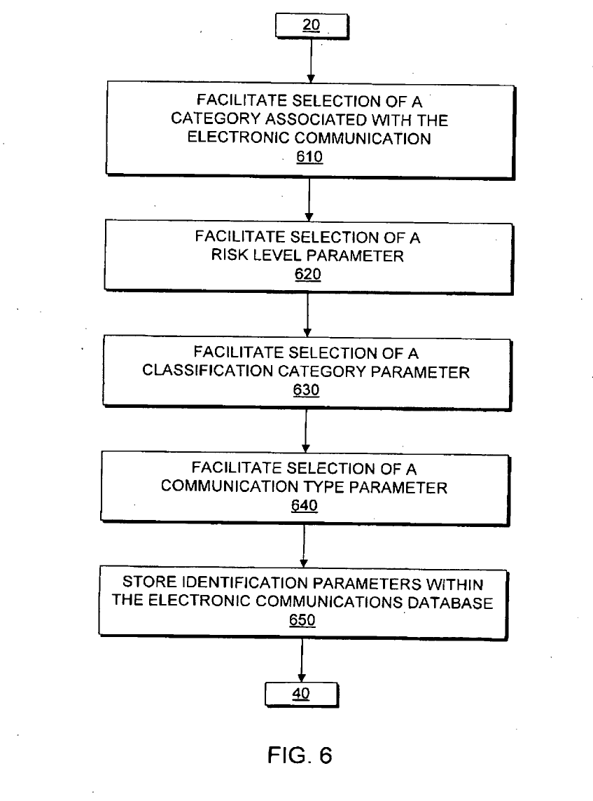

FIG. 6 is a flow diagram illustrating a method to facilitate selection of one or more identification parameters associated with the electronic communication. As shown in FIG. 6, in one embodiment, subsequent to retrieval of the set of communication parameters, at processing block 610, selection of a category parameter associated with the electronic communication is facilitated.

At processing block 620, selection of a risk level parameter associated with the electronic communication is facilitated. At processing block 630, selection of a classification category parameter associated with the electronic communication is facilitated.

At processing block 640, selection of a communication type parameter associated with the electronic communication is facilitated. Finally, at processing block 650, the category parameter, the risk level parameter, the classification category parameter, and the communication type parameter are stored within the electronic communications database 310.

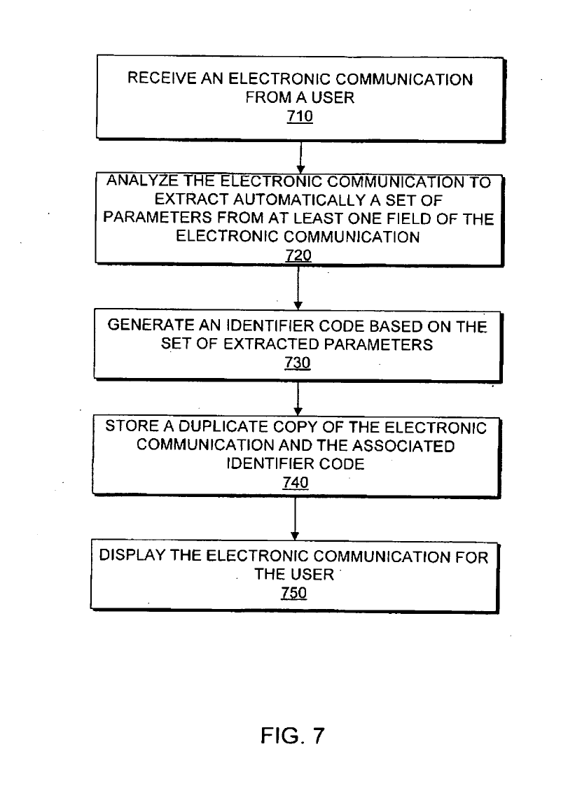

FIG. 7 is a flow diagram illustrating a method to control and manage electronic communications, according to an alternate embodiment of the invention. As shown in FIG. 7, at processing block 710, an electronic communication is received from a user. In one embodiment, a sender user 140 performs an electronic communication set-up routine, such as, for example, creates an electronic mail message, and transmits the electronic communication to a recipient user 141 via the client machine 130 and the network 120. The system 100 receives the communication information directly from the client machine 131 coupled to the recipient user 141, or, alternatively, from the network 120. In one embodiment, as shown in FIG. 2, the processing engine 104 within the system 100 receives the communication information via the communication interface module 102 and/or the network 120 prior to being displayed to the user 141.

Next, at processing block 720, the received electronic communication is analyzed and a set of parameters are automatically extracted from one or more fields of the electronic communication. In one embodiment, the electronic communication contains electronic communication information input by the sender user 140 and stored within one or more fields of the communication. The system 100, through its processing engine 104, for example, analyzes the communication information and retrieves automatically one or more parameters from respective fields of the electronic communication, such as, for example, a sender identification parameter, including sender identification information, such as an electronic address, any employee code and/or position within an organization, if available, a source parameter, including information related to the entity that originated the electronic communication, an attachment parameter including attachment information, a content parameter including a description of the content information, and whether the communication is transmitted intra-network or through an external network, and a temporal parameter, which contains the date and time of the transmission. It is to be understood by persons skilled in the art that various other parameters may be extracted from corresponding fields of the received electronic communication without departing from the scope of the present invention.

At processing block 730, an identifier code associated with the received electronic communication is generated automatically based on the set of extracted parameters. In one embodiment, the system 100 assembles the identifier code, code element by code element, to generate an identifier code sequence based on the set of extracted parameters, as described in detail in connection with FIGS. 1 through 4. As described above, the processing engine 104 within the system 100 incorporates the set of extracted parameters into respective fields of the identifier code, such as, for example, the network field 402, the attachment field 403, the temporal field 404, the sender field 409, the recipient field 410, and the description field 411, and assembles the identifier code for the electronic communication.

At processing block 740, a duplicate copy of the received electronic communication is generated and stored within the data storage device 106 together with the corresponding identifier code, such that subsequent production of the electronic communication may be facilitated through various search protocols. In one embodiment, the processing engine 104 within the system 100 generates a duplicate copy of the communication and stores the copy and the associated identifier code within respective databases of the data storage device 106.

Finally, at processing block 750, the received electronic communication is displayed for the recipient user 141 on a display device within the client machine 131.

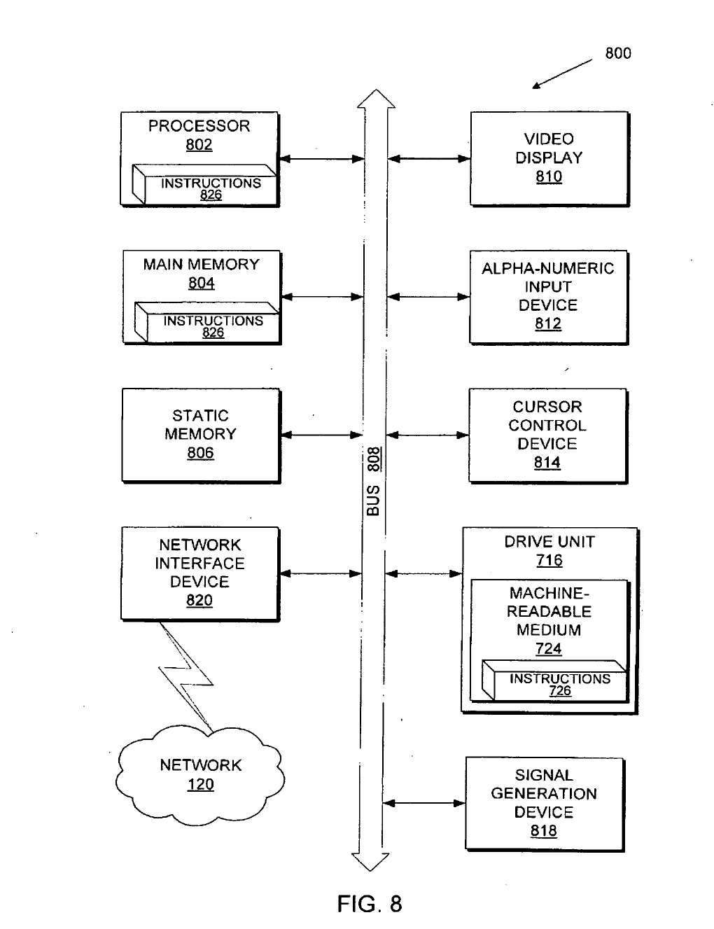

FIG. 8 shows a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
generating an electronic communication at a point of origin coupled to a sender user; and
managing status of said electronic communication at said point of origin based on a predetermined number of selectable parameters associated with said electronic communication.

2. The method according to claim 1, wherein said managing further comprises:
receiving communication information corresponding to said electronic communication from said sender user; and
retrieving a set of communication parameters from said communication information.

3. The method according to claim 2, wherein said retrieving further comprises retrieving at least one communication parameter from a group consisting of sender user identification information, recipient user identification information, electronic attachment information, transmission type information, description information, and temporal information related to said electronic communication.

4. The method according to claim 2, wherein said managing further comprises:
presenting a plurality of identification parameters related to said electronic communication to said sender user; and
facilitating selection of at least one identification parameter by said sender user.

5. The method according to claim 4, wherein said facilitating further comprises facilitating selection of a category parameter associated with said electronic communication.

6. The method according to claim 4, wherein said facilitating further comprises facilitating selection of a risk level parameter associated with said electronic communication.

7. The method according to claim 4, wherein said facilitating further comprises facilitating selection of a classification category parameter associated with said electronic communication based on substantive content of said electronic communication.

8. The method according to claim 4, wherein said facilitating further comprises facilitating selection of a communication type parameter associated with said electronic communication.

9. The method according to claim 4, wherein said managing further comprises:
generating an identifier code associated with said electronic communication, said identifier code further comprising a plurality of fields populated with said set of communication parameters and said selected identification parameters.

10. The method according to claim 9, wherein said managing further comprises:
storing a duplicate copy of said electronic communication and said associated identifier code within a storage device prior to transmission to a recipient user.

11. A computer readable medium containing executable instructions, which, when executed in a processing system, cause said processing system to perform a method comprising:
generating an electronic communication at a point of origin coupled to a sender user; and
managing status of said electronic communication at said point of origin based on a predetermined number of selectable parameters associated with said electronic communication.

12. The computer readable medium according to claim 11, wherein said managing further comprises:
receiving communication information corresponding to said electronic communication from said sender user; and
retrieving a set of communication parameters from said communication information.

13. The computer readable medium according to claim 12, wherein said retrieving further comprises retrieving at least one communication parameter from a group consisting of sender user identification information, recipient user identification information, electronic attachment information, transmission type information, description information, and temporal information related to said electronic communication.

14. The computer readable medium according to claim 12, wherein said managing further comprises:
presenting a plurality of identification parameters related to said electronic communication to said sender user; and
facilitating selection of at least one identification parameter by said sender user.

15. The computer readable medium according to claim 14, wherein said facilitating further comprises facilitating selection of a category parameter associated with said electronic communication.

16. The computer readable medium according to claim 14, wherein said facilitating further comprises facilitating selection of a risk level parameter associated with said electronic communication.

17. The computer readable medium according to claim 14, wherein said facilitating further comprises facilitating selection of a classification category parameter associated with said electronic communication based on substantive content of said electronic communication.

18. The computer readable medium according to claim 14, wherein said facilitating further comprises facilitating selection of a communication type parameter associated with said electronic communication.

19. The computer readable medium according to claim 14, wherein said managing further comprises:
generating an identifier code associated with said electronic communication, said identifier code further comprising a plurality of fields populated with said set of communication parameters and said selected identification parameters.

20. The computer readable medium according to claim 19, wherein said managing further comprises:
storing a duplicate copy of said electronic communication and said associated identifier code within a storage device prior to transmission to a recipient user.

21. A system comprising:
a client machine coupled to a sender user to generate an electronic communication at a point of origin; and
a processing engine coupled to said client machine to manage status of said electronic communication at said point of origin based on a predetermined number of selectable parameters associated with said electronic communication.

22. The system according to claim 21, wherein said processing engine further receives communication information corresponding to said electronic communication from said sender user, and retrieves a set of communication parameters from said communication information.

23. The system according to claim 22, wherein said processing engine further retrieves at least one communication parameter from a group consisting of sender user identification information, recipient user identification information, electronic attachment information, transmission type information, description information, and temporal information related to said electronic communication.

24. The system according to claim 22, wherein said processing engine further presents a plurality of identification parameters related to said electronic communication to said sender user in said client machine, and facilitates selection of at least one identification parameter by said sender user.

25. The system according to claim 24, wherein said processing engine further facilitates selection of a category parameter associated with said electronic communication.

26. The system according to claim 24, wherein said processing engine further facilitates selection of a risk level parameter associated with said electronic communication.

27. The system according to claim 24, wherein said processing engine further facilitates selection of a classification category parameter associated with said electronic communication based on substantive content of said electronic communication.

28. The system according to claim 24, wherein said processing engine further facilitates selection of a communication type parameter associated with said electronic communication.

29. The system according to claim 24, wherein said processing engine further generates an identifier code associated with said electronic communication, said identifier code further comprising a plurality of fields populated with said set of communication parameters and said selected identification parameters.

30. The system according to claim 29, wherein said processing engine further stores a duplicate copy of said electronic communication and said associated identifier code within a storage device prior to transmission to a recipient user.

31. A system comprising:
means for generating an electronic communication at a point of origin coupled to a sender user; and
means for managing status of said electronic communication at said point of origin based on a predetermined number of selectable parameters associated with said electronic communication.

32. The system according to claim 31, further comprising:
means for receiving communication information corresponding to said electronic communication from said sender user; and
means for retrieving a set of communication parameters from said communication information.

33. The system according to claim 32, further comprising means for retrieving at least one communication parameter from a group consisting of sender user identification information, recipient user identification information, electronic attachment information, transmission type information, description information, and temporal information related to said electronic communication.

34. The system according to claim 32, further comprising:
means for presenting a plurality of identification parameters related to said electronic communication to said sender user; and
means for facilitating selection of at least one identification parameter by said sender user.

35. The system according to claim 34, further comprising means for facilitating selection of a category parameter associated with said electronic communication.

36. The system according to claim 34, further comprising means for facilitating selection of a risk level parameter associated with said electronic communication.

37. The system according to claim 34, further comprising means for facilitating selection of a classification category parameter associated with said electronic communication based on substantive content of said electronic communication.

38. The system according to claim 34, further comprising means for facilitating selection of a communication type parameter associated with said electronic communication.

39. The system according to claim 34, further comprising:
means for generating an identifier code associated with said electronic communication, said identifier code further comprising a plurality of fields populated with said set of communication parameters and said selected identification parameters.

40. The system according to claim 39, further comprising:
means for storing a duplicate copy of said electronic communication and said associated identifier code within a storage device prior to transmission to a recipient user.
